(19) United States
(12) Patent Application Publication
(10) Pub. No.: US 2015/0032813 A1
(43) Pub. Date: Jan. 29, 2015

(54) TECHNIQUES TO LOCATE AND DISPLAY CONTENT SHARED WITH A USER

(71) Applicant: Microsoft Corporation, Redmond, WA (US)

(72) Inventors: Gaurav Doshi, Kirkland, WA (US); Mary David, Seattle, WA (US); Eli Block, Bellevue, WA (US); Ajey Shah, Bellevue, WA (US); Alex Burst, Kirkland, WA (US); Dave Chan, Sammamish, WA (US); Dwane Codrington, New Castle, WA (US)

(73) Assignee: Microsoft Corporation, Redmond, WA (US)

(21) Appl. No.: 14/145,743

(22) Filed: Dec. 31, 2013

Related U.S. Application Data
(60) Provisional application No. 61/859,394, filed on Jul. 29, 2013.

(51) Int. Cl. H04L 29/06

(52) U.S. Cl. CPC H04L 65/403
USPC 709/204

(57) ABSTRACT

Techniques to locate and display content shared with a member of an online community are described. In an embodiment, a technique may include receiving a request from a client device for all content items in an online community that are shared with a first member of the online community. All of the content items in the online community that are shared with the first member are identified and the identified content items are provided to the requesting client device.

### RELATED APPLICATION

This application claims priority to, and benefit of, U.S. Provisional Patent Application 61/859,394 titled “TECHNIQUES TO LOCATE AND DISPLAY CONTENT SHARED WITH A USER” filed on Jul. 29, 2013, the entirety of which is hereby incorporated by reference.

### BACKGROUND

Many online communities, including collaborative work environments and social networking sites, allow a member to share content with other members. The shared-with member may receive some notification about the shared content, for example, in an e-mail message, short message service (SMS) message, instant message, notification within the social network and so forth. Locating and accessing the shared-with content later, however, can be more difficult because the shared-with member may have to look back at older messages, or may have deleted or archived the access information. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to locate and display content shared with a user. Some embodiments are particularly directed to techniques to locate and display content shared with a member of an online community in a manner that simplifies and automates the location and display of shared content. In one embodiment, for example, an apparatus may comprise a processor circuit and a sharing component executing on the processor circuit to: receive a request from a client device for all content items in an online community that are shared with a first member of the online community; identify all of the content items in the online community that are shared with the first member; and provide the identified content items to the requesting client device. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to locate and view shared content.

FIG. 2 illustrates an embodiment of an operating environment for the system of FIG. 1.

FIG. 3 illustrates an embodiment of an operating environment for the system of FIG. 1.

FIG. 4 illustrates an embodiment of a content item.

FIG. 5 illustrates a first message flow for the system of FIG. 1.

FIG. 6 illustrates a second message flow system of FIG. 1.

FIG. 7 illustrates an embodiment of a user interface view.

FIG. 8 illustrates an embodiment of a second user interface view.

FIG. 9 illustrates an embodiment of a third user interface view.

FIG. 10 illustrates an embodiment of a centralized system for the system of FIG. 1.

FIG. 11 illustrates an embodiment of a distributed system for the system of FIG. 1.

FIG. 12 illustrates an embodiment of a logic flow for the system of FIG. 1.

FIG. 13 illustrates an embodiment of a logic flow for the system of FIG. 1.

FIG. 14 illustrates an embodiment of a computing architecture.

FIG. 15 illustrates an embodiment of a communications architecture.

### DETAILED DESCRIPTION

Various embodiments are directed to techniques to locate and display content shared with a member of an online community. In various embodiments, content shared with a member of an online community is associated with a data field that includes identifying information for the shared-with member. A user interface element may, upon selection by the shared-with member, automatically locate all content items in the online community having the shared-with member's identifying information in the associated data field. The located content items may then be displayed to the shared-with member, for example, as a set of links or references to those content items. In this way, the shared-with member can see and access all of the content from the online community that has been shared with him or her in one place. As a result, the embodiments can improve efficiency and user experience for the members of the online community.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

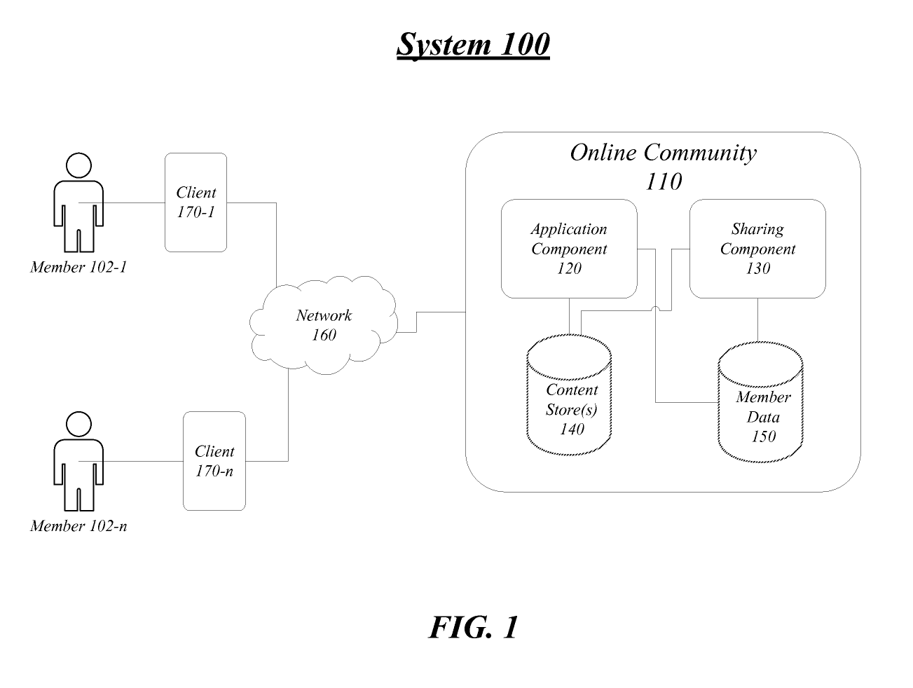

FIG. 1 illustrates a block diagram for a system 100. In one embodiment, the system 100 may comprise a computer-implemented system 100 having an online community 110 in communication with one or more members 102-1, . . . 102-n (collectively, members 102) via a network 160 and respective client devices, such as clients 170-1, . . . 170-n, where n is a positive integer.

Online community 110 may represent a grouping of computing resources, such as servers, storage devices, software and communications infrastructure that collectively allow a group of users, e.g. members 102, to, at least, view and share content with one another. An embodiment of online community 110 may include a collaborative business environment, such as, but not limited to, MICROSOFT SHAREPOINT or GOGGLE DOCS. Another embodiment of online community 110 may include a social networking service, such as GOOGLE+, MYSPACE, TWITTER, FACEBOOK, and so forth.

Online community 110 may include various functional components, such as application component 120 and sharing component 130. Additional or alternative components may also be included in online community 110 without departing from the spirit of the embodiments. The components of online community 110 may be resident on one or multiple computing devices, and may be in one geographic location or distributed across multiple geographic locations.

Application component 120 may provide, in some embodiments, a software application that a member can use to interact with data and/or other members. Online community 110 may have no, one, or multiple different application components 120. Some examples of application components 120 may include, without limitation, word processing applications, spreadsheet applications, presentation applications, online collaboration applications, multimedia editing applications, messaging applications, and so forth.

Sharing component 130 may provide functions to allow a member to share a content item with another member, and to allow a member to locate and view content items shared with them. Sharing component 130 may provide user interface elements, or may interact with a user interface component (not shown) to provide the sharing functionality. The operations of sharing component 130 are described further below.

Online community 110 may also store data or have access to stored data, such as content store 140 and member data 150. Content store 140 may include one or more data storage devices to store content items. Content items may comprise logically discrete items that can be viewed and interacted with by members 102. Content items may include, for example and without limitation, files, directories of files, word processing documents, spreadsheet documents, multimedia documents, web pages, and so forth. Content store 140 may represent one physical storage device, or a collection of multiple storage devices accessible to, at least, sharing component 130. In an embodiment, a content store 140 may also include a content store that is not logically or physically part of online community 110 but that is accessible to online community 110, for example, publically available web sites.

Member data 150 may include stored data about the members 102 of online community 110. Member data 150 may include, at least, an identifier for a member that can be used to mark content shared with the member. The identifier may be used, for example, as a component in authenticating a member when the member attempts to access online community 110, e.g. as a user name part of a user name and password authentication operation. The identifier may be sufficiently distinct to uniquely the member from all other members in online community 110. Member data 150 may further include other member information, such as, without limitation, a messaging address, a profile, directory and/or contact information, and so forth.

Online community 110 may be accessible via a network such as network 160. Network 160 may be any private or public network, or public/private hybrid, that allows a member 102 to access online community 110 via a client 170. Network 160 may be a wired or wireless network. Network 160 may be a private intranet, or a public internet, such as the Internet.

Members 102 may represent individual people, businesses, or groups of individuals who can bely represented in online community 110. A member, such as member 102-1 may have, at least, an identifier in online community 110, which may be stored in member data 150.

Members 102 may interact with online community 110 via client devices such as clients 170-1, 170-n (collectively, clients 170), where n is a positive integer. A client 170 may include any electronic device capable of communicating with online community 110, e.g. sending and receiving messages, control directives, and/or signals. Examples of clients 170 may include, without limitation, personal computers, smart phones, tablet computers, laptop computers, game consoles, and so forth. A client 170 may receive control directives from a member 102, e.g. in the form of keyboard input, pointer device input, touchscreen input, voice command input, motion commands, video capture input, and so forth. Clients 170 may therefore communicate with, and perform actions with, online community 110 at the direction of members 102.

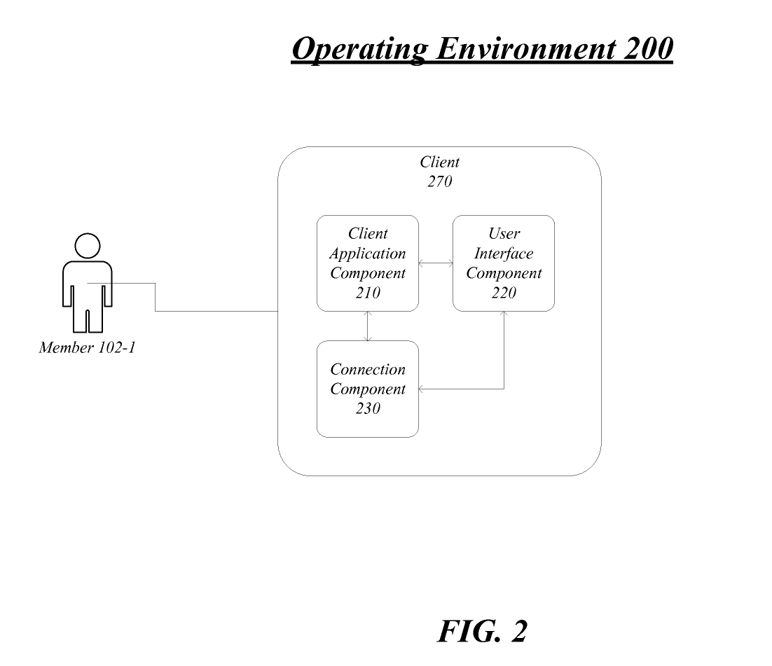

FIG. 2 illustrates an embodiment of an operating environment 200 for the system 100. As shown in FIG. 2, operating environment 200 may include a client 270. Client 270 may be an embodiment of client 170. Client 270 may include various functional components, such as client application component 210, user interface component 220 and connection component 230. Additional and/or alternative components may also be in operation on client 270. The functional components as described herein may include software that when executed on a processing circuit of client 270 (not shown) provides the functionality described.

Client application component 210 may provide, in some embodiments, a software application that a member 102-1 can use to interact with online community 110. Client application component 210 may be a dedicated stand-alone application that can communicate with online community 110. Client application component 210 may include a multi-purpose application, such as a web browser, that can communicate with online community 110 to receive content and functional capabilities to present to the member, e.g. via web portal.

User interface (UI) component 220 may provide various graphical user interface elements and functionality that allow the member 102-1 to view content and give control directives to manipulate content provided via online community 110. UI component 220 may be a component of an operating system executing on client 270, or may be a component of client application component 210, or a combination of operating system and client application UIs.

Connection component 230 may include hardware and instructions that allow client 270, and in particular, client application component 210, to connect to online community 110 and to exchange data, such as content, control directives, and so forth.

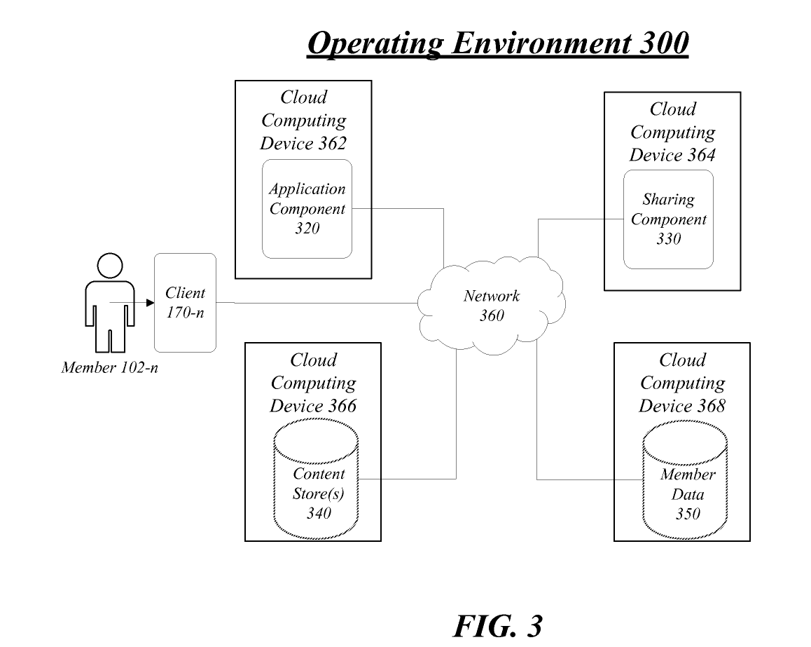

FIG. 3 illustrates an embodiment of an operating environment 300 for the system 100. In FIG. 3, components 320 and 330 may be embodiments of components 120 and 130, respectively, from FIG. 1; and data stores 340 and 350 may be embodiments of content store 140 and member data 150, respectively. As shown in FIG. 3, online community 110 may be implemented in a cloud network environment. For example, application component 320 may be stored and executed on cloud computing device 362, while sharing component 330 may be stored and executed on cloud computing device 364, physically separate from cloud computing device 362. Content store(s) 340 may be stored on still another cloud computing device 366, while member data 350 may be stored on still another cloud computing device 368. The cloud computing devices 362, 364, 366, and 368 may all be communicatively coupled via network 360, which may be an embodiment of network 160. Other arrangements may be possible, for example, the various components and data stores may be stored and/or executed on any combination of cloud computing devices

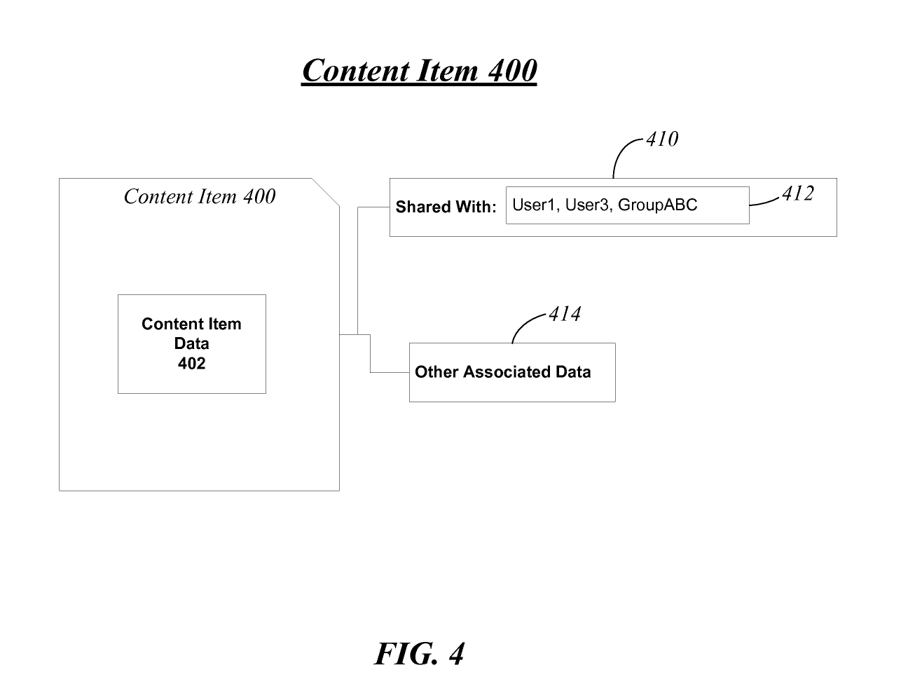

FIG. 4 illustrates an embodiment of content item 400 for the system 100. Content item 400 may be an example of content items stored in content store 140. As shown in FIG. 4, content item 400 may include content item data 402. Content item data 402 may include the actual content of the content item, e.g. the text of a word processing document, data in a spreadsheet document, images and markup language in a web page, and so forth. Content item data 402 may also include formatting information and other non-visible data related to display and presentation of content item 400.

Content item 400 may have an associated “shared-with” data field 410. Shared-with data field 410 may be a multi-value data field that stores the identifiers 412 of any members with whom content item 400 has been shared. As shown in FIG. 4, content item 400 has been shared with three members: User1, User2, and Group ABC.

Content item 400 may have other associated data 414. Other associated data 414 may include, for example, metadata about content item 400, such as an author identifier, permissions information, a last-edited date, keywords, and so forth. Other associated data 414 may include any data that online community 110 uses to make content item 400 accessible, searchable, and/or modifiable by the members 102.

In an embodiment where content items are not stored within online community 110, such as content items on publically available web sites, sharing component 130 may not be able to associate a member identifier directly with the content item. In order to share a content item that is located outside of the online community, sharing component 130 may maintain a table or other data structure that stores the identifier of the shared-with member in association with a link or reference to the shared content item. When a member then requests to see content items shared with that member, sharing component 130 may search both the content in content store 140 and in the table or data structure.

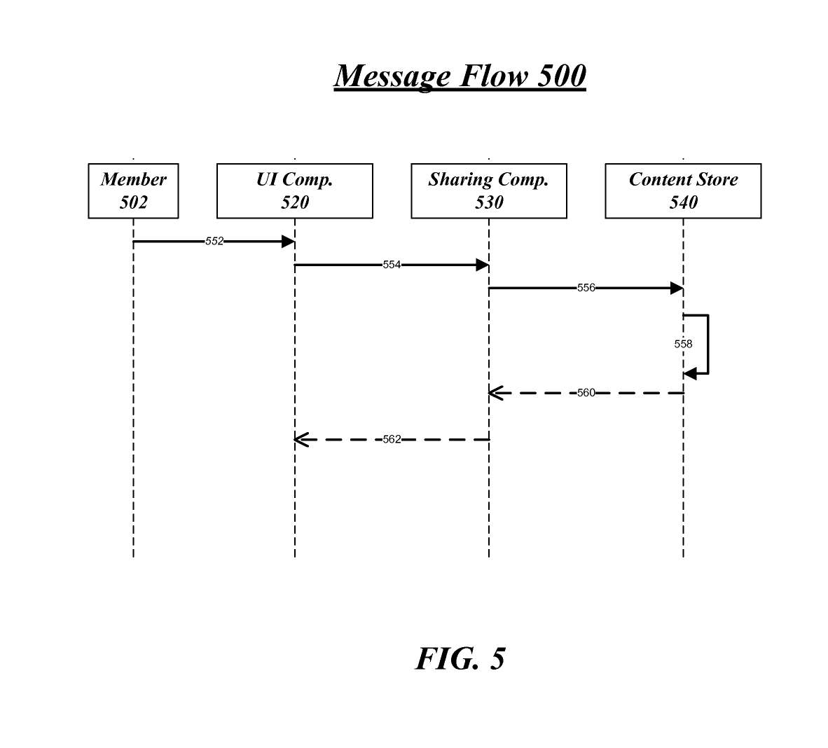

FIG. 5 illustrates an embodiment of a message flow 500 for the system 100. As shown in FIG. 5, member 502, UI component 520, sharing component 530, and content store 540 may represent member 102-1, UI component 220, sharing component 130 and content store 140, respectively. Message flow 500 may represent messages exchanged among the illustrated components when a member selects a UI option to view all content items shared with the member.

In message flow 500, member 502 may issue a control directive 552, via a single user interface element, to UI component 520. The control directive may select a function to view content items shared with member 502.

UI component 520 may request, via message 554 to sharing component 530, all content items from the online community that are shared with member 502. Message 554 may include an identifier of member 502. In an embodiment, the identifier of member 502 may be obtained when member 502 logs in or otherwise authenticates himself/herself to online community 110.

Sharing component 530 may search for, or request, in message 556, all content items in content store 540 that are shared with member 502. Sharing component 530 may, for example, search for all content items having a “shared with” association with the member's identifier.

Content store 540 may return all content items, or references to all content items, that are shared with member 502 in message 560 to sharing component 530. Sharing component 530 may then provide the content items, or references to the content items, to UI component 520 in message 562.

UI component 520 may then display a collection of the received content items in a user interface view to member 502 on the client device. The display may include, for example, a list of content item references, a graphical view of icons representing the content items, and so forth.

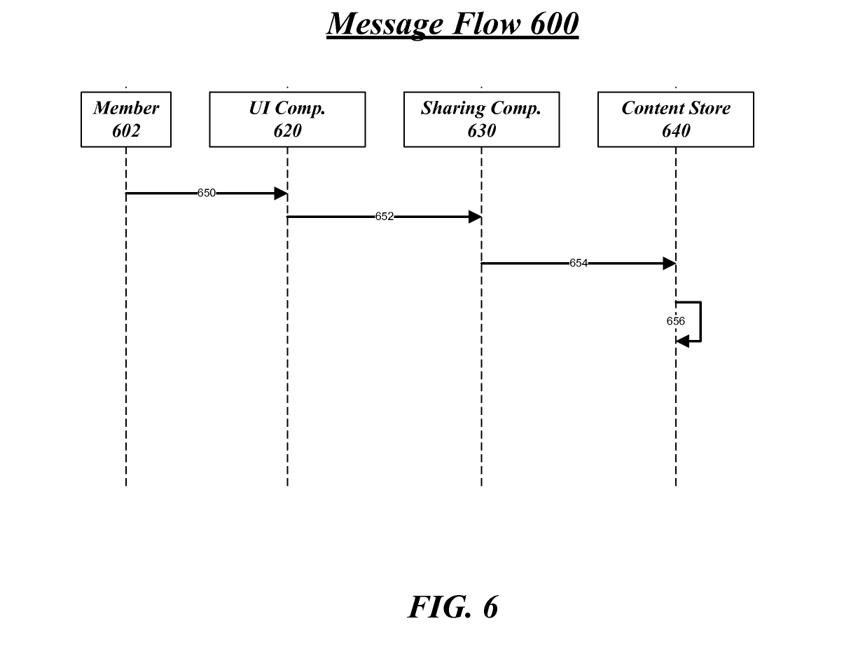

FIG. 6 illustrates an embodiment message flow 600 for the system 100. As shown in FIG. 6, member 602, UI component 620, sharing component 630, and content store 640 may represent member 102-n, UI component 220, sharing component 130 and content store 140, respectively. Message flow 600 may represent messages exchanged among the illustrated components when a member selects a UI option to share a content item with another member.

In message flow 600, member 602 may issue a control directive 650 to UI component 620. The control directive may select a function to share a content item with another member. Control directive 650 may include an identifier of the member with which member 602 wishes to share the content item. Alternatively, control directive 650 may cause UI component 620 to prompt member 602 to provide an identifier for the shared-with member (not shown).

UI component 620 may send a request 652 to sharing component 630 with the identifier of the shared-with member to share the content item. The request 652 may include an identifier of the content item.

Sharing component 630 may retrieve or identify the content item in content store 640 with message 654. Message 654 may include an instruction or operation to associate the identifier of the shared-with member with the content item in content store 640. The identifier may be added to a multi-value data field associated with the content item, in operation 656.

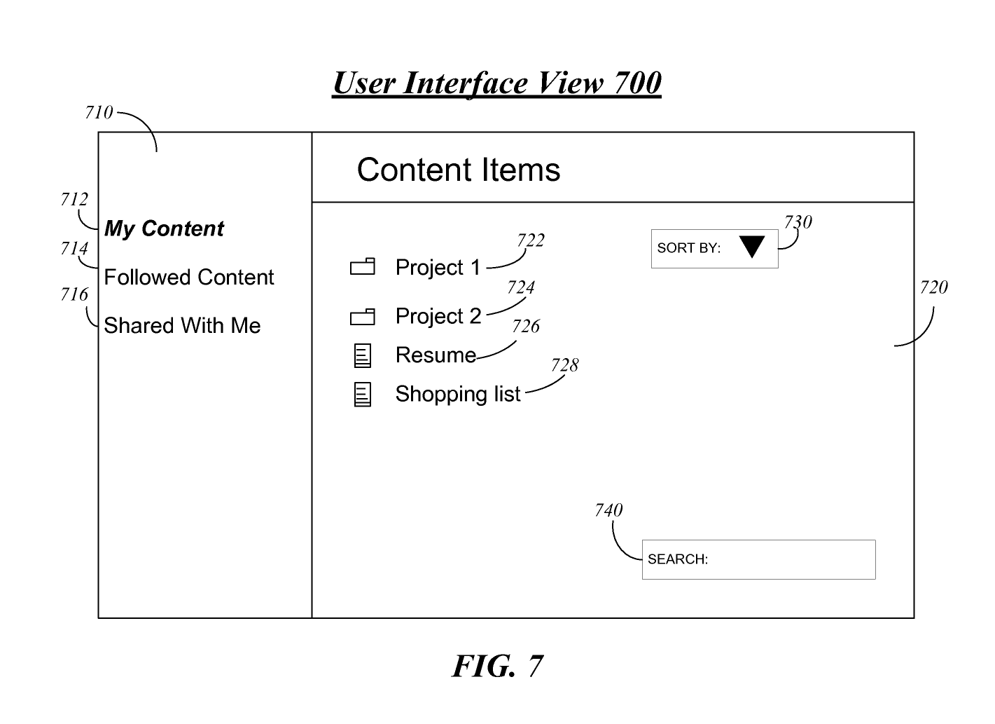

FIG. 7 illustrates an embodiment of user interface view 700 for the system 100. UI view 700 may function as a “home” page for a member in online community 110, or as an entry point for the member to content items in online community 110. UI view 700 may generally present content items that the member has created and/or interacted with.

As shown in FIG. 7, UI view 700 may include a navigation pane 710 and a content pane 720. Navigation pane 710 may include various selectable options that affect what is displayed in content pane 720. For example, in FIG. 7, my content option 712 is selected, and causes content pane 720 to show a list of content items that the member has recently created, modified, and/or viewed. The listing may include, for example, folders or directories, such as folder 722 and folder 724, and documents, such as documents 726 and 728. The type of a content item may be indicated, for example, by a graphic or icon next to a title or other identifier of the content item. While FIG. 7 shows a text-based list of references to content items, other display methods may be used. For example, the content items may be shown as a grid of icons representing the content items. The embodiments are not limited to these examples.

Other selectable options may include a followed content option 714 and a shared with me option 716. When selected, followed content option 714 may cause content pane 720 to display a list of content items that the member has selected to “follow.” Following may include receiving notifications when the followed content item has been modified, commented on, shared, and so forth. When selected, the shared with option 716 may cause content pane 720 to display content items that were shared with the member.

UI view 700 may also include a sort UI element, e.g. sort drop-down menu 730. The content items may be sorted according to one or more sort criterion, for example, alphabetically by title, by content item type, by date created or modified, combinations of these, or other criteria. Other methods of providing a sorting operation may be used and are not limited to this example.

UI view 700 may also include a searching operation, e.g. via search field 740. Search field 740 may accept search terms from member input in the form of one or more control directives. Online community 110 may provide a search function to identify content items displayed in the content pane 720 that meet the search criteria entered in search field 740 and may display the identified content items in content pane 720 or in another UI object.

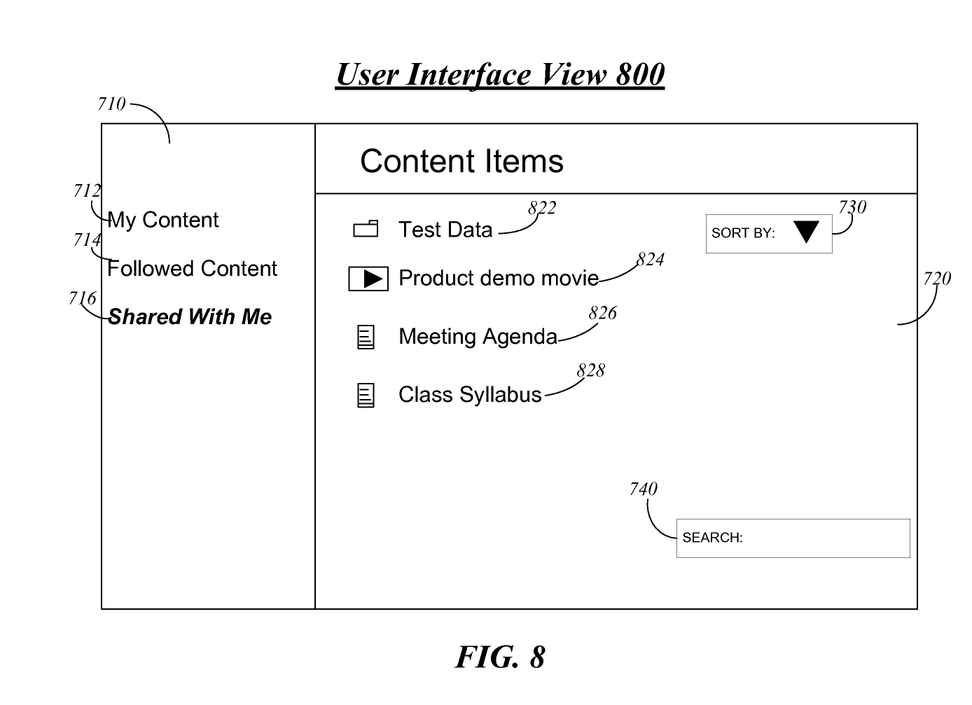

FIG. 8 illustrates an embodiment of user interface view 800 for the system 100. UI view 800 may be similar to UI view 700, however with the shared with me option 716 selected. As shown in FIG. 8, when shared with me option 716 is selected, content pane 720 may display a collection of content items that have been shared with the member. As shown in FIG. 8, the content items may include, without limitation, a folder or directory 822, a video file 824, and document files, such as documents 826 and 828. As in UI view 700, the content items displayed may be sorted as described with respect to UI view 700, and additionally, for example, by a shared-on date, alphabetically by the shared-by member, and so forth. Similarly, the member may search for particular shared-with content items using search field 740.

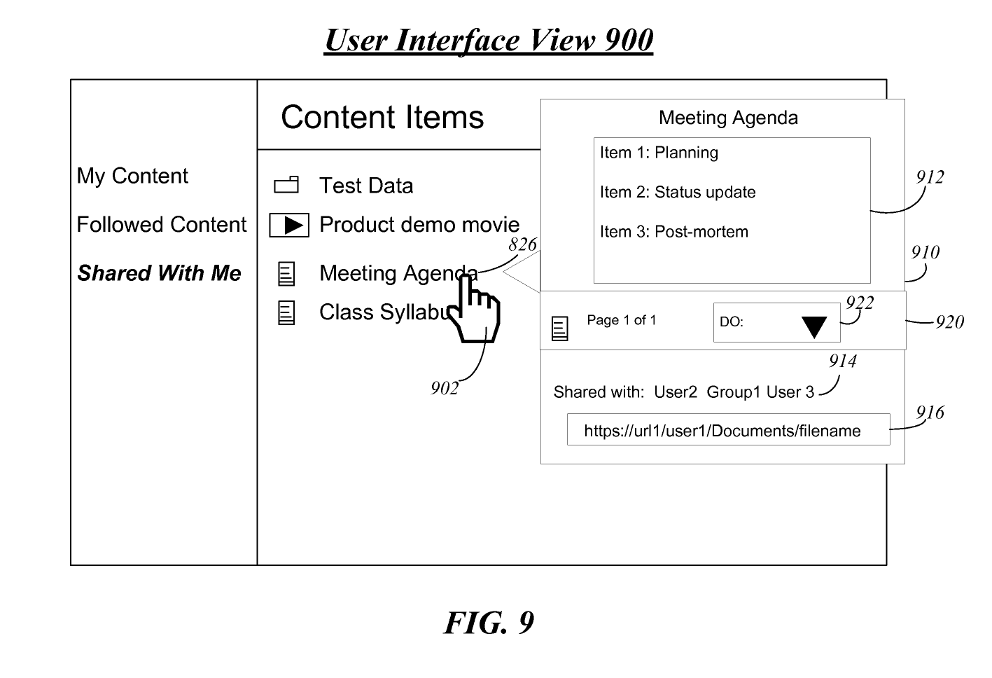

FIG. 9 illustrates an embodiment of user interface view 900 for the system 100. UI view 900 may reflect UI 800, but when an indicator, such as a pointer 902, is in proximity to a content item shown in content pane 720. As shown in FIG. 9, pointer 902 may represent, for example, a cursor illustrating a position of an input device, e.g. a mouse, stylus, finger on a track pad, and so forth. Pointer 902 may also represent the position of a finger or electronic pen on a touch-sensitive surface. Pointer 902 may also represent a position of a selection or navigation gesture as captured by a motion detection apparatus.

When pointer 902 is detected in proximity to a content item listing, e.g. document 826, a preview pane 910 may be displayed. Preview pane 910 may provide, for example, a preview 912 of document 826. Preview pane 910 may also include information about the content item in information pane 920, such as the number of pages, the author, and so forth. Information pane 914 may provide selectable options 922 related to the documents, such as to open, follow, share or view in the content item's location.

Preview pane 910 may also display other information about the content item, such as the other members with whom the content item is shared 914, and an address 916 for the storage location of the content item.

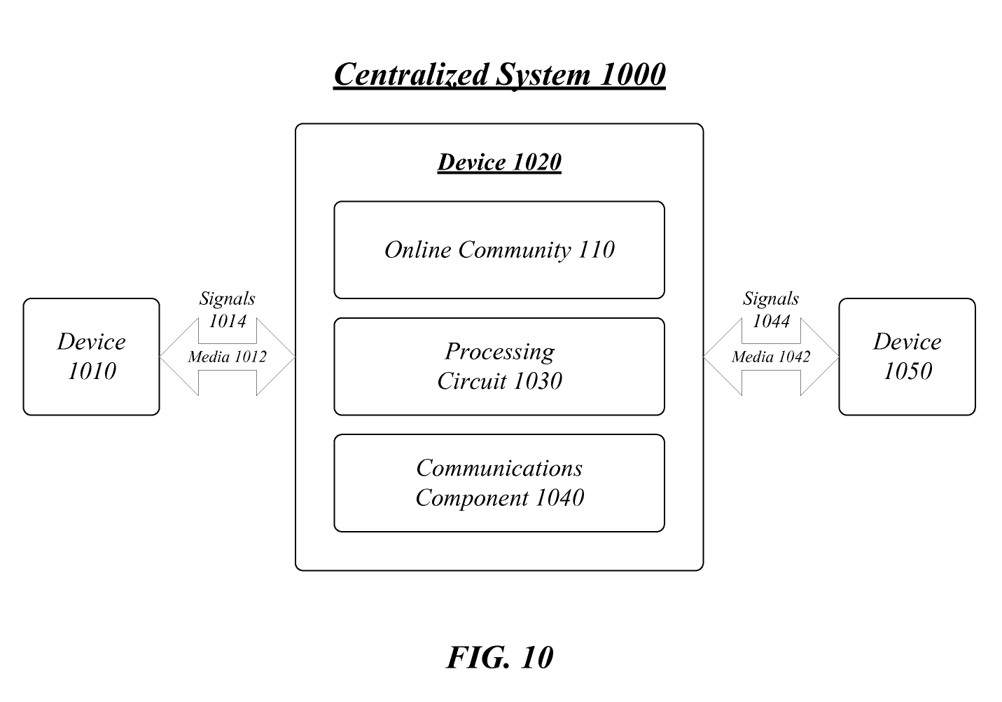

FIG. 10 illustrates a block diagram of a centralized system 1000. The centralized system 1000 may implement some or all of the structure and/or operations for the online community 110 in a single computing entity, such as entirely within a single device 1020.

The device 1020 may comprise any electronic device capable of receiving, processing, and sending information for the online community 110. Examples of an electronic device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 1020 may execute processing operations or logic for the online community 110 using a processing circuit 1030. The processing circuit 1030 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 1020 may execute communications operations or logic for the online community 110 using communications component 1040. The communications component 1040 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1040 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1012, 1042 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 1020 may communicate with other devices 1010, 1050 over a communications media 1012, 1042, respectively, using communications signals 1014, 1044, respectively, via the communications component 1040. The devices 1010, 1050 may be internal or external to the device 1020 as desired for a given implementation. Devices 1010 and 1050 may represent clients, e.g. clients 170-n, and/or other sources of content items that may be shared.

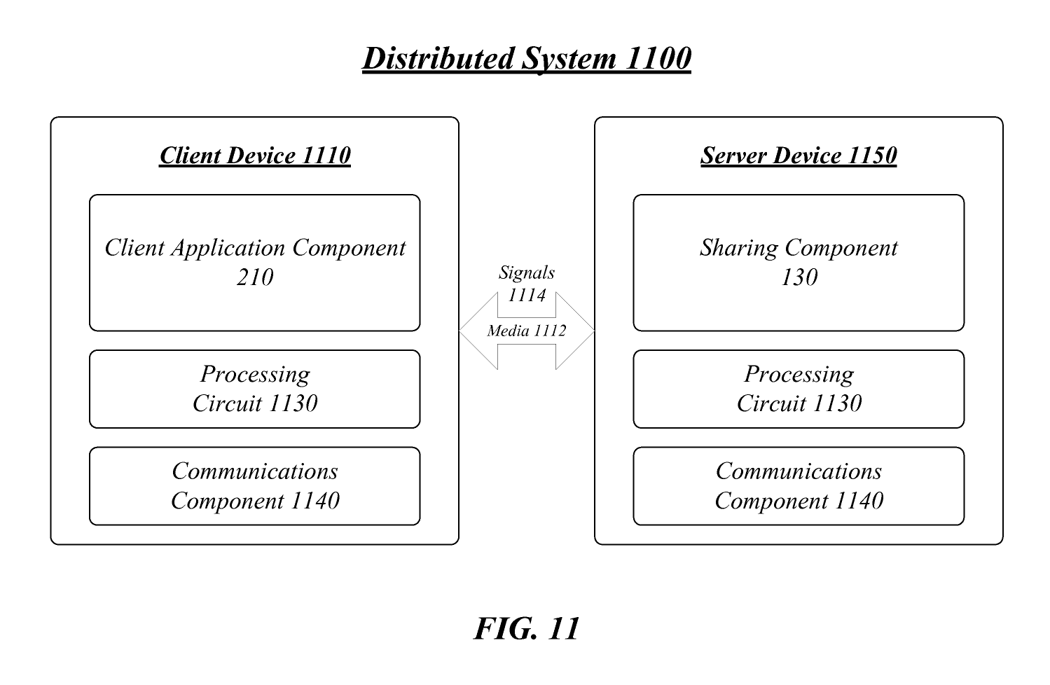

FIG. 11 illustrates a block diagram of a distributed system 1100. The distributed system 1100 may distribute portions of the structure and/or operations for the system 100 across multiple computing entities. Examples of distributed system 1100 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1100 may comprise a client device 1110 and a server device 1150. In general, the client device 1110 and the server device 1150 may be the same or similar to the client device 1020 as described with reference to FIGS. 2, 3 and 10. For instance, the client device 1110 and the server device 1150 may each comprise a processing circuit 1130 and a communications component 1140 which are the same or similar to the processing circuit 1030 and the communications component 1040, respectively, as described with reference to FIG. 10. In another example, the devices 1110, 1150 may communicate over a communications media 1112 using communications signals 1114 via the communications components 1140.

The client device 1110 may comprise or employ one or more client programs that operate to perform various methodologies in accordance with the described embodiments. In one embodiment, for example, the client device 1110 may implement client application component 320.

The server device 1150 may comprise or employ one or more server programs that operate to perform various methodologies in accordance with the described embodiments. In one embodiment, for example, the server device 1150 may implement any of the cloud computing devices 362, 364, 366, and/or 368, or online community 110.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

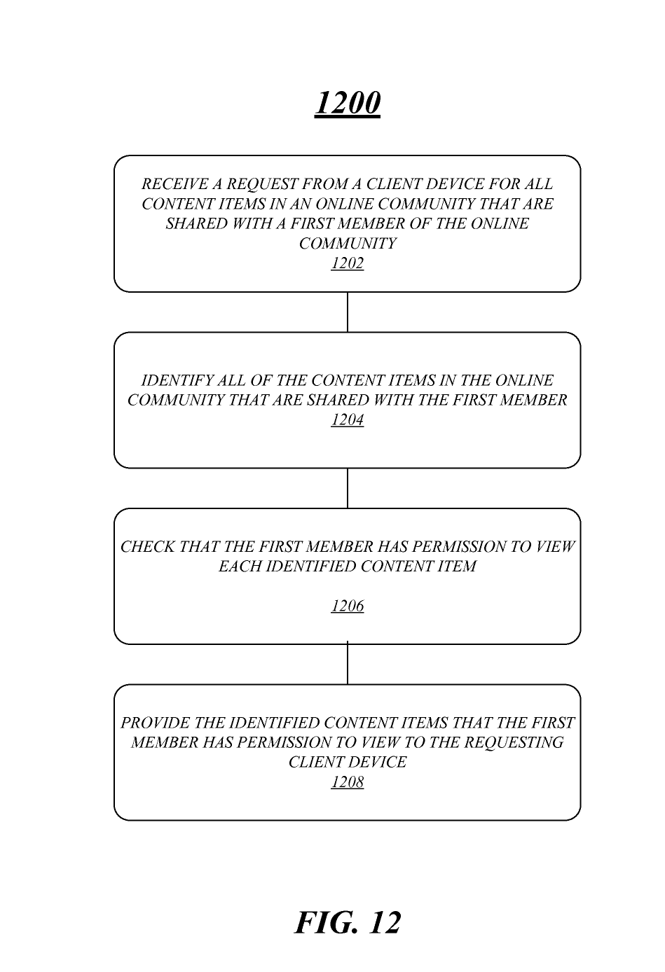

FIG. 12 illustrates one embodiment of a logic flow 1200. The logic flow 1200 may be representative of some or all of the operations executed by one or more embodiments described herein.

In the illustrated embodiment shown in FIG. 12, the logic flow 1200 may receive a request from a client device for all content items in an online community that are shared with a first member of the online community at block 1202. For example, sharing component 130 may receive a request from client 270, via UI component 220 and/or client application component 210 for all content items shared with member 102-1.

The logic flow 1200 may identify all of the content items in the online community that are shared with the first member at block 1204. For example, sharing component 130 may search content store 140 for all content items having the first member's identifier in the content item's multi-value data field 410. The logic flow 1200 may check that the first member has permission to view each identified content item at block 1206. For example, sharing component 130 may check each identified content item's other associated data 414 to see if the first member has permission to view the content item.

The logic flow 1200 may provide the identified content items that the first member has permission to view to the requesting client device at block 1208. For example, sharing component 130 may return references, e.g. links, pointers, uniform resource locators, addresses, and so forth, to the identified content items to UI component 220. UI component 220 may then display the content items to the first member.

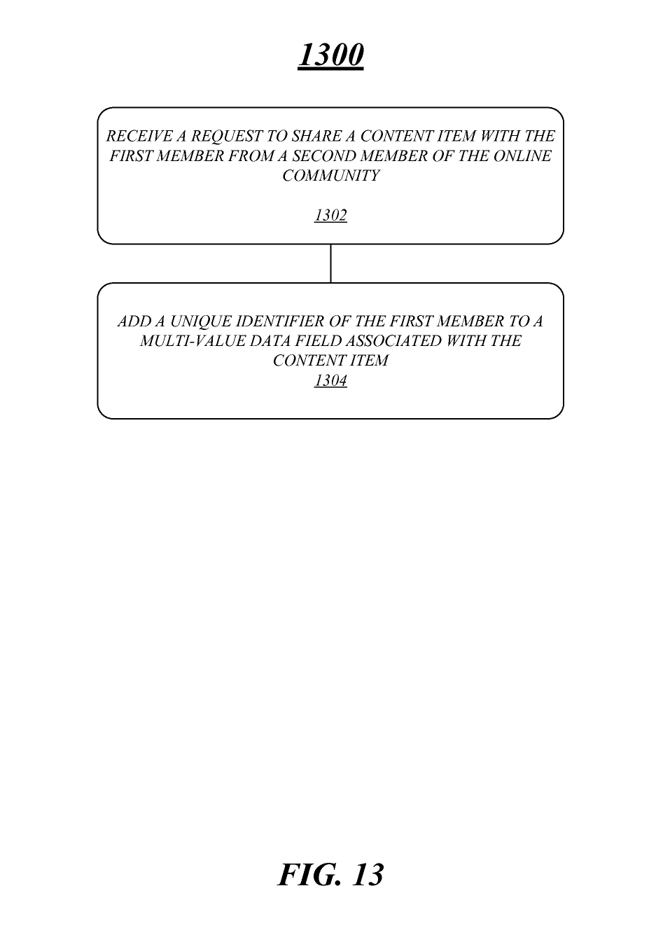

FIG. 13 illustrates one embodiment of a logic flow 1300. The logic flow 1300 may be representative of some or all of the operations executed by one or more embodiments described herein.

In the illustrated embodiment shown in FIG. 13, the logic flow 1300 may receive a request from a second member to share a content item with a first member of the online community at block 1302. The request may identify the first member with an identifier of the first member, and may include identifying information about the content item to be shared. Sharing component 130 may receive the request.

The logic flow 1300 may add the identifier to a multi-valued data field associated with the shared content item in block 1304. Sharing component 130 may add the identifier to the multi-valued data field of the content item in content store 140. Sharing component 130 may store a reference to the content item and may add the identifier to the multi-valued data field of the stored reference for a content item that is not stored in content store 140.

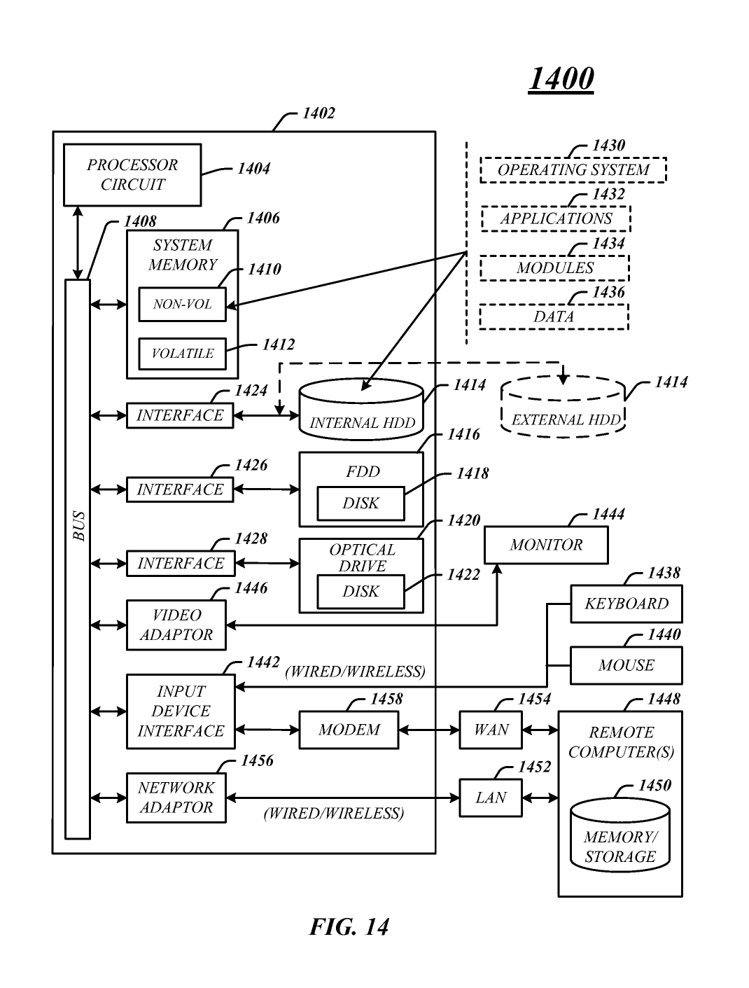

FIG. 14 illustrates an embodiment of an exemplary computing architecture 1400 suitable for implementing various embodiments as previously described. In one embodiment, the computing architecture 1400 may comprise or be implemented as part of an electronic device. Examples of an electronic device may include those described with reference to FIG. 10, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1400.

As shown in FIG. 14, the computing architecture 1400 comprises a processing circuit 1404, a system memory 1406 and a system bus 1408. The processing circuit 1404 can be any of various commercially available hardware processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing circuit 1404.

The system bus 1408 provides an interface for system components including, but not limited to, the system memory 1406 to the processing circuit 1404. The system bus 1408 can be any of several types of bus structure that may further interconnect to a memory bus (with or without a memory controller), a peripheral bus, and a local bus using any of a variety of commercially available bus architectures. Interface adapters may connect to the system bus 1408 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1400 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a tangible computer-readable medium, which may be read and executed by one or more processors to enable performance of the operations described herein.

The system memory 1406 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1406 can include non-volatile memory 1410 and/or volatile memory 1412. A basic input/output system (BIOS) can be stored in the non-volatile memory 1410.

The computer 1402 may include various types of computer-readable storage media in the form of one or more lower speed memory units, including an internal (or external) hard disk drive (HDD) 1414, a magnetic floppy disk drive (FDD) 1416 to read from or write to a removable magnetic disk 1418, and an optical disk drive 1420 to read from or write to a removable optical disk 1422 (e.g., a CD-ROM or DVD). The HDD 1414, FDD 1416 and optical disk drive 1420 can be connected to the system bus 1408 by a HDD interface 1424, an FDD interface 1426 and an optical drive interface 1428, respectively. The HDD interface 1424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1410, 1412, including an operating system 1430, one or more application programs 1432, other program modules 1434, and program data 1436. In one embodiment, the one or more application programs 1432, other program modules 1434, and program data 1436 can include, for example, the various applications and/or components of the system 100.

A user can enter commands and information into the computer 1402 through one or more wire/wireless input devices, for example, a keyboard 1438 and a pointing device, such as a mouse 1440. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing circuit 1404 through an input device interface 1442 that is coupled to the system bus 1408, but can be connected by other interfaces such as a parallel port, IEEE 1394 serial port, a game port, a USB port, an IR interface, and so forth.

A monitor 1444 or other type of display device is also connected to the system bus 1408 via an interface, such as a video adaptor 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wire and/or wireless communications to one or more remote computers, such as a remote computer 1448. The remote computer 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wire/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the LAN 1452 through a wire and/or wireless communication network interface or adaptor 1456. The adaptor 1456 can facilitate wire and/or wireless communications to the LAN 1452, which may also include a wireless access point disposed thereon for communicating with the wireless functionality of the adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wire and/or wireless device, connects to the system bus 1408 via the input device interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

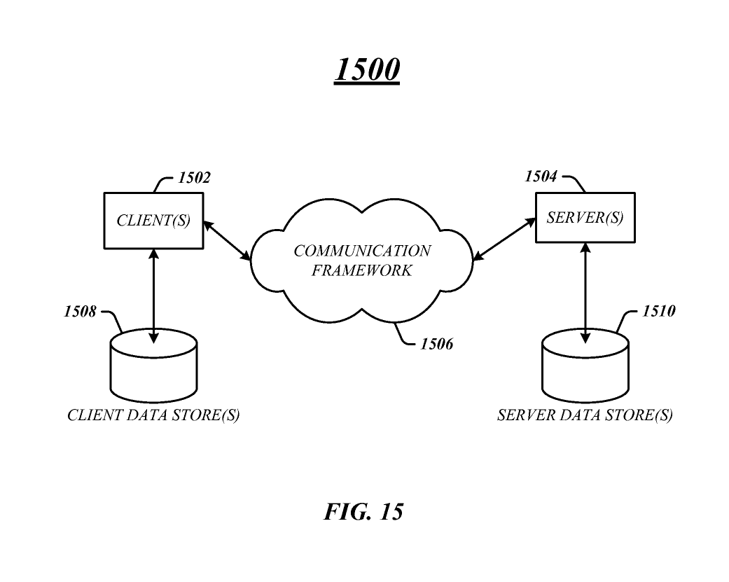

FIG. 15 illustrates a block diagram of an exemplary communications architecture 1500 suitable for implementing various embodiments as previously described. The communications architecture 1500 includes various common communications elements, such as a transmitter, receiver, transceiver, radio, network interface, baseband processor, antenna, amplifiers, filters, power supplies, and so forth. The embodiments, however, are not limited to implementation by the communications architecture 1500.

As shown in FIG. 15, the communications architecture 1500 comprises includes one or more clients 1502 and servers 1504. The clients 1502 may implement the client device 1110. The servers 1504 may implement the server device 1150. The clients 1502 and the servers 1504 are operatively connected to one or more respective client data stores 1508 and server data stores 1510 that can be employed to store information local to the respective clients 1502 and servers 1504, such as cookies and/or associated contextual information.

The clients 1502 and the servers 1504 may communicate information between each other using a communication framework 1506. The communications framework 1506 may implement any well-known communications techniques and protocols. The communications framework 1506 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1506 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1502 and the servers 1504. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor circuit; and
a sharing component executing on the processor circuit to:
receive a request from a client device for all content items in an online community that are shared with a first member of the online community;
identify all of the content items in the online community that are shared with the first member; and
provide the identified content items to the requesting client device.

2. The apparatus of claim 1, the sharing component further to:
receive a request to share a content item with the first member from a second member of the online community; and
add an identifier of the first member to a multi-value data field associated with the content item.

3. The apparatus of claim 2, the sharing component further to identify a content item shared with the first member by searching for the identifier of the first member in the multi-value data field of each content item in the online community.

4. The apparatus of claim 2, the sharing component further to:
receive a request to share a content item with a plurality of members of the online community; and
add an identifier of each member in the plurality of members to the multi-value data field associated with the content item.

5. The apparatus of claim 1, wherein the first member comprises a group of members, the group having an identifier separate from identifiers associated with each member in the group.

6. The apparatus of claim 1, the sharing component further to provide an identified content item when the first member has permission to view the content item, and not provide an identified content item when the first member does not have permission to view the content item.

7. The apparatus of claim 1, the sharing component further to provide a reference to each of the identified content items to the requesting client.

8. A computer-implemented method, comprising:
receiving a request from a client device for all content items in an online community that are shared with a first member of the online community;
identifying all of the content items in the online community that are shared with the first member; and
providing the identified content items to the requesting client device.

9. The computer-implemented method of claim 8, comprising authenticating the first member with the online community via the client device.

10. The computer-implemented method of claim 8, comprising:
receiving a request to share a content item with the first member from a second member of the online community; and
adding an identifier of the first member to a multi-value data field associated with the content item.

11. The computer-implemented method of claim 10, comprising identifying a content item shared with the first member by searching for the identifier of the first member in the multi-value data field of each content item in the online community.

12. The computer-implemented method of claim 10, comprising:
receiving a request to share a content item with a plurality of members of the online community; and
adding an identifier of each member in the plurality of members to the multi-value data field associated with the content item.

13. The computer-implemented method of claim 8, wherein the first member comprises a group of members, the group having an identifier separate from the identifiers of the members in the group.

14. The computer-implemented method of claim 8, comprising providing an identified content item when the first member has permission to view the content item, and not providing an identified content item when the first member does not have permission to view the content item.

15. At least one computer-readable storage medium comprising instructions that, when executed, cause a system to:
connect a client device of a first member of an online community to the online community;
receive a control directive via a single user interface element from the first member to view content items shared with the first member;
request all content items from the online community that are shared with the first member;
receive the requested content items; and
display a collection of the received content items in a user interface view on the client device.

16. The computer-readable storage medium of claim 15, comprising instructions that when executed cause the system to display a preview pane of a received content items when an indicator is in proximity to the content item in the displayed collection.

17. The computer-readable storage medium of claim 15, comprising instructions that when executed cause the system to:
receive a control directive from the first member to share a content item with a second member of the online community;
receive an identifier for the second member; and
provide the identifier for the second member to the online community to associate with the content item.

18. The computer-readable storage medium of claim 15, comprising instructions that when executed cause the system to:
receive a control directive from the first member to sort the collection of received content items according to at least one sort criterion; and
sort the displayed collection in response to the control directive.

19. The computer-readable storage medium of claim 15, comprising instructions that when executed cause the system to:
receive a control directive from the first member to search the collection for content items related to at least one search criterion;
searching the collection in response to the control directive; and
displaying results of the searching.

20. The computer-readable storage medium of claim 15, comprising instructions that when executed cause the system to:
receive a control directive to select a content item in the displayed collection; and
open the selected content item for at least one of viewing and editing.
